(19) United States
(12) Patent Application Publication
(10) Pub. No.: US 2011/0071900 A1
(43) Pub. Date: Mar. 24, 2011

(54) ADVERTISEE-HISTORY-BASED BID GENERATION SYSTEM AND METHOD FOR MULTI-CHANNEL ADVERTISING

(75) Inventors: Anil Kamath, Palo Alto, CA (US); Abhishek Pani, San Francisco, CA (US)

(73) Assignee: Efficient Frontier, Sunnyvale, CA (US)

(21) Appl. No.: 12/884,828

(22) Filed: Sep. 17, 2010

Related U.S. Application Data
(60) Provisional application No. 61/243,873, filed on Sep. 18, 2009.

(51) Int. Cl. G06Q 30/00

(52) U.S. Cl. 705/14.46; 705/14.71

(57) ABSTRACT

Disclosed are methods, apparatus, systems, and non-transitory, tangible computer-readable media associated with generating bids for multi-channel advertising environments, including in embodiments, generating a multi-channel advertising model. A multi-channel advertising model may be generated and used to estimate the effect of various advertisements and/or events that occur to an individual advertisee across various modeled advertising channels. An advertisee may be tracked across multiple channels, such as, for example, by using one or more cookies as the advertisee visits various web sites. Embodiments may calculate marginal contributions to a conversion event by various advertising events that have occurred along the sales funnel. Various revenue attributions may be generated as a function of a marginal contribution that an event had on the final conversion. Embodiments may provide an advertiser with estimates of the advertisee's value through time as well as how the advertisee's value evolves based on events taken by the advertisee and/or by changing exposure levels across multiple channels. From these estimates, a bidding strategy directing bids for advertising events may be generated for use by an advertiser.

### BACKGROUND

Advertisers wishing to place advertisements on online channels are presented with many options from which to choose. These options may be priced differently, and may deliver different results. For example, search engines allow advertisers to pay for listings, where the cost per click to bring a visitor from the search engine is different based on keyword or position in the listing. In another example, web sites may also allow advertisements to be displayed at different sizes and/or locations and based on keywords or addresses visited by an viewer.

Current systems attempt to help advertisers allocate resources across various online channels. In some systems, advertising effects on viewers (or “advertisees”) are modeled. These models may help produce data from which the advertiser can determine the utility of performing an advertising event, such as bidding for advertising space on a web site or paying for positions in search result listings.

However, many currents systems model revenue attribution based on advertisees' last event before the point of conversion (e.g., the point where the advertisee purchases or transacts for goods or services offered by the advertiser on the advertiser's product page or web site). These models may only capture the conversion moment, which is a moment of intent of an advertisee, rather than an entire sales funnel (e.g., an advertisee's journey through advertising stages of awareness, interest, desire, and intent). In some such systems, return on investment of such intent-based channels is assumed to be higher than those that participate in generating awareness, interest, or desire.

For example, assume that a firm is running both search and display campaigns online. Since search represents an explicit intent stated by a web surfer, a majority of the revenue conversions will be attributed to search. However, contributions to branding or interest generation for the product by the display campaigns are discounted, since these ads did not directly result in a conversion. While some systems utilize pre-determined heuristics to apportion portions of the revenue to various events assumed to be along the advertisee's path, many of these approaches do not support cross-channel bidding strategy optimization. Instead, current systems simply use pre-determined heuristics to allocate budgets across various mediums. Additionally, current systems simply aggregate data for all advertisees for a given advertiser and then determine a bid that is common for all web surfers who will be subject to the advertisement. These systems do not provide for analysis of individual advertisees.

### BRIEF DESCRIPTION OF THE DRAWINGS

FIG. 1 illustrates a block diagram of selected components of a multi-channel bid generation system,

FIG. 2 illustrates a process for generating and executing bidding strategies based on event histories for advertisees,

FIG. 3 illustrates a process for tracking revenue event histories,

FIG. 4 illustrates a process for generating a multi-channel advertising environment model,

FIG. 5. illustrates a process for determining latent factors for the generated model,

FIG. 6 illustrates a process for generating clusters of advertisees and metadata for the generated model,

FIG. 7 illustrates a first process for performing value estimation for advertisees in the generated model,

FIG. 8 illustrates an example network flow model used in the value estimation of FIG. 7,

FIG. 9 illustrates a second process for performing value estimation for advertisees in the generated model,

FIG. 10 illustrates an example visualization of predicted revenue based on various budget amounts;

FIG. 11 illustrates example visualizations of suggested budget allocations; and

FIG. 12 illustrates an example computing device configured to practice various aspects of the earlier described methods, all ranged in accordance with various embodiments of the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The herein described subject matter sometimes illustrates different components or elements contained within, or connected with, different other components or elements. It is to be understood that such depicted architectures are merely examples, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Various aspects of the subject matter described herein are described using terms commonly employed by those skilled in the art to convey the substance of their work to others skilled in the art. However, it should be apparent to those skilled in the art that alternate implementations may be practiced with only some of the described aspects. For purposes of explanation, specific numbers, materials, and configurations are set forth in order to provide a thorough understanding of the illustrative examples. However, it should be apparent to one skilled in the art that alternate embodiments may be practiced without the specific details. In other instances, well-known features are omitted or simplified in order not to obscure the illustrative embodiments.

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and e, etc.” is used, in general such a construction is intended in the sense one having skill in the art would understand the convention (e.g., “a system having at least one of A, B, and C” would include but not be limited to systems that have A alone, B alone, C alone, A and B together, A and e together, Band e together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, Band C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Various operations may be described as multiple discrete operations in turn, in a manner that may be helpful in understanding embodiments; however, the order of description should not be construed to imply that these operations are order dependent. Also, embodiments may have fewer operations than described. A description of multiple discrete operations should not be construed to imply that all operations are necessary. Also, embodiments may have fewer operations than described. A description of multiple discrete operations should not be construed to imply that all operations are necessary.

The disclosure is drawn, inter alia, to techniques, methods, apparatuses, systems, articles of manufacture, and non-transitory tangible computer-readable media related to generating bids for advertising events in a multi-channel advertising environment by tracking advertisees.

Described embodiments include techniques, methods, apparatuses, systems, articles of manufacture, and non-transitory tangible computer-readable media which may be associated with generating bids for a multi-channel advertising environment, including, in embodiments, generating a multi-channel advertising model. In various embodiments, the multi-channel advertising model may be used to track and estimate the effect of various advertisements and/or events that occur to an individual advertisee across various modeled advertising channels. In various embodiments, an advertisee may be tracked across multiple channels, such as, for example, by using one or more cookies as the advertisee visits various web sites on a web browser. In various embodiments, the system may be configured to calculate incremental contributions to a conversion event by various advertising events that have occurred along the sales funnel. In various embodiments, various revenue attributions may be generated as a function of a marginal contribution that an event had on the final conversion. In various embodiments, the model may provide the advertiser with estimates of the advertisee's value through time as well as how the advertisee's value evolves based on actions taken by the advertisee and/or by changing exposure levels across multiple channels.

In various embodiments, the multi-channel bid generation system may use the generated model to generate a bidding strategy directing allocation of resources to marketing options and advertising events, such as search keywords and advertising buys, so as to meet specific composite goals and performance criteria. This strategy may help the advertiser determine one or more bids for a next event. In various embodiments, generation of bids may be performed by the system in a real-time environment. In various embodiments, the system may aid an advertiser in determining an advertising or bidding budget, such as by presenting visualizations. In some embodiments, these visualizations may illustrate relationships between budget amounts and predicted revenues. In other embodiments, these visualizations may break down budgets and/or revenues on a per-channel basis to help aid the advertiser in making advertising decisions.

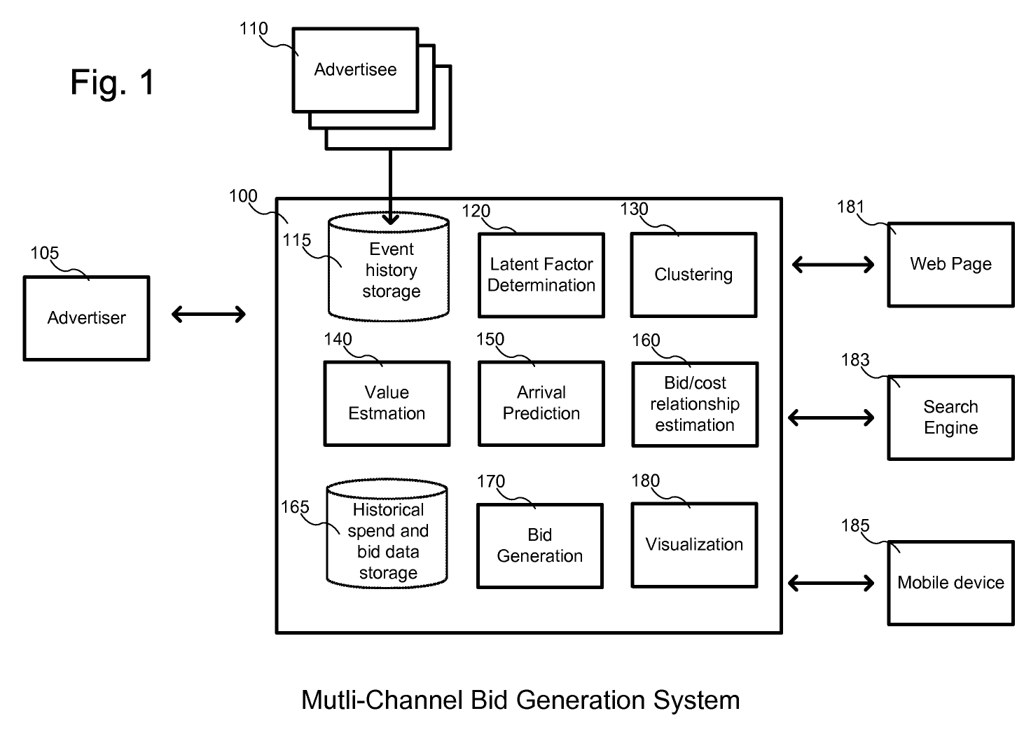

FIG. 1 illustrates a block diagram of selected components of a multi-channel bid generation system 100 according to various embodiments. In the illustrated example, the multi-channel bid generation system 100 communicates with an advertiser 105 to facilitate the advertiser in selecting bids for various advertising events, such as, but not limited to, search keywords and/or placed advertisements. In various embodiments, the advertiser may be advertising a good, a service, a location (real or virtual) or other products or entities for which advertising may prove useful. In various embodiments, the advertiser may represent a single individual or a business. In various embodiments, the advertiser may interact with the multi-channel bid generation system 100 through interfaces provided by the multi-channel bid generation system 100, such as through a web-based interface, or through a dedicated application. In various embodiments, these interactions may comprise one or more visualizations provided which the multi-channel bid generation system 100 provides to the advertiser 105, as will be described below.

Also, as illustrated in FIG. 1, one or more advertisees may interact with the multi-channel bid generation system 100, such as by the system tracking and/or receiving event histories for the advertisee, which may be stored in the event history storage 115. In various embodiments, the advertisee 110 may be a single individual, such as a person visiting web sites. In other embodiments, the advertisee 110 may represent multiple individuals who may be associated together according to demographics, work, physical location, etc. As illustrated, in various embodiments, multiple advertisees 110 may interact with the multi-channel bid generation system 100 at one time. In various embodiments, event histories may be tracked, received and stored for the various advertisees with regard to multiple products; in other embodiments, multiple advertisees may be tracked with respect to the same product. Examples of tracking event history information are described in greater detail below.

In various embodiments, the package shipment facilitation system 100 may also interact with one or more entities which provide marking options, such as web page 181, search engine 183, and/or mobile device 185. For example, the multi-channel bid generation system 100 may facilitate the placing of bids for advertising events with the web page, search engine, and/or mobile device. In various embodiments, the multi-channel bid generation system 100 may act as a marketplace for bidding on advertising events, and may act directly to place bids on the various advertising events. In other embodiments, the multi-channel bid generation system 100 may not directly interact with the entities providing advertising events, but instead may provide the advertiser 105 with one or more bidding strategies so that the advertiser 105 may themselves place bids for advertising events.

In various embodiments, the multi-channel bid generation system 100 may comprise one or more modules, such as software, hardware, and/or firmware modules to perform various modeling, optimization, and bid generation operations. In various embodiments, the modules may themselves interact with the advertiser 105, the advertisee 110, and/or the entities providing marketing options 181, 183, and 185. In various embodiments, the modules may be merged with each other divided further, or omitted altogether.

In various embodiments, the multi-channel bid generation system 100 may comprise a latent factor determination module 120, which may analyze event history stored in the event history storage to determine one or more latent factors, which need not necessarily have a semantic meaning associated. In various embodiments, an example of a latent factor could be high travel intent along with low intent for stock trading. Embodiments of processes performed by the latent factor determination module 120 are discussed below. The multi-channel bid generation system 100 may also, in various embodiments, comprise a clustering module 130, which may cluster advertisees and/or metadata during multi-channel modeling. In various embodiments, an example of a cluster would be males in California in the 20-25 age-group with high propensity to travel but low intent towards stock trading. Embodiments of processes performed by the clustering module 130 are discussed below. In various embodiments, the multi-channel bid generation system 100 may further comprise a value estimation module 140, which may perform value estimation for one or more advertisees to determine the value provided by the advertisee toward conversion based on events in the event history. Embodiments of processes performed by the value estimation module 140 are discussed below.

Further, in various embodiments, the multi-channel bid generation system 100 may further comprise additional modules used for optimization of models generated through operation of the aforementioned latent factor modeling module 120, clustering module 130, and value estimation module 140. These modules may include the arrival prediction module 150, which may predict the arrival rate of the advertisee at various websites/platforms on which ad can be shown. These modules may also include the bid/cost relationship estimation module 160 which may estimate relationships between bids and costs incurred from these bids, such as cost-per-thousand impressions (CPM) or cost-per-click (CPC) evaluations. In various embodiments, the bid/cost relationship estimation module 160 may utilize historical spend and bid data to perform the estimation. In various embodiments, the historical data may be stored, such as on historical spend and bid data storage 165.

The multi-channel bid generation system 100 may also, in various embodiments, comprise a bid generation module 170. In various embodiments, the bid generation module 170 may generate one or more bids, such as through developing a bidding strategy directing placement of one or more bids. In various embodiments, the bid generation module 170 may generate a bidding strategy through optimization of a model generated through operation of the other modules. In one embodiment, the optimization may be performed by solving for one or more objective functions using the model while subject to one or more constraints. Embodiments of processes performed by the bid generation module 170 are discussed below.

The multi-channel bid generation system 100 may also, in various embodiments, comprise a visualization module 180. In various embodiments, the visualization module 180 may generate one or more visualizations to be presented to an advertiser in order that the advertiser may be informed about the bid generation process or about other metrics. In various embodiments, the visualization module 180 may generate visualizations for, for example, relationships between predicted revenues and allocated advertising budget amounts, cost distributions for a generated bidding strategy, and/or predicted revenue distributions for a generated bidding strategy. In various embodiments, the visualization module 180 may provide visualizations to an advertiser through various means, such as by generating a web page containing visualizations through a web browser, or by presenting visualizations on a dedicated software application.

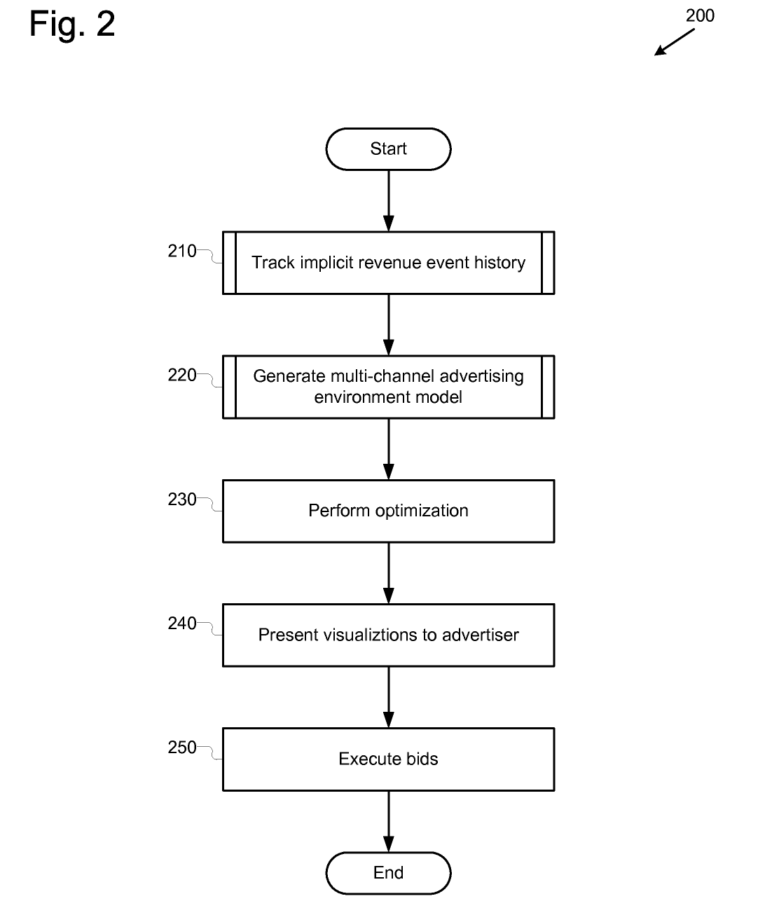

FIG. 2 illustrates an example process 200 for the multi-channel bid generation system 100 to generate one or more bids based at least in part on event history experienced by advertisees. In various embodiments, the operations illustrated in process 200 may be combined, split into multiple separate operations, or omitted entirely. The process may begin at operation 210, where the multi-channel bid generation system 100 may track implicit revenue event history for individual advertisees. Embodiments of various operations performed as part of operation 210 are described below.

At operation 220, the multi-channel bid generation system 100 may generate a multi-channel advertising environment model. In various embodiments, operation 220 may be performed by one or more of latent factor modeling module 110, clustering module 120, and/or value estimation module 130. Embodiments of various operations performed as part of operation 220 are described below.

Next, at operation 230, the multi-channel bid generation system 100 may perform an optimization using the model to determine one or more bids to provide in a bidding strategy. In various embodiments, operation 220 may be performed by the bid generation module 170, using information obtained from the event prediction module 140 and the bid/cost relationship estimation module 160. In various embodiments, the multi-channel bid generation system 100 may perform optimization by solving a mathematical optimization problem that aims to increase and/or maximize one or more pre-determined measurable goals for the advertiser over a pre-determined time horizon. These measurable goals may be defined by objective functions. Examples of these objective functions include, but are not limited to: maximizing revenues, maximizing profits, maximizing traffic, and/or minimizing traffic acquisition/customer acquisition costs. Additionally, in various embodiments, the multi-channel bid generation system 100 may perform optimization on the models while observing pre-determined constraints. Such constraints may include, but are not limited to:
minimum/maximum constraints on traffic volume directed to specific websites, keywords, ad networks, and/or marketing channels;
minimum/maximum position and bid constraints on keywords;
minimum/maximum bid constraints on bids for display platforms;
maximum cost-per-thousand or cost-per-click constraints for keywords, keyword groups, web sites, networks, and/or channels; and
cost per customer acquisition constraints which cannot exceed a certain target.

In various embodiments, the optimization problem may be modeled as a mathematical programming problem. For example, if models involved are linear models, the system may optimize by solving a linear programming problem, using a standard linear programming/optimization solver like CPLEX or M1NOS. In other embodiments, the optimization problem may be formulated as a non-linear problem, and solved employing any one of a number of non-linear optimization techniques. The solution to the optimization problem can be a bidding strategy and/or an advertising budget allocation strategy. In various embodiments, the bid generation module 170 may utilize information from the advertiser about an amount of revenue the advertiser is willing to forgo to expose segments of the advertisee population to ads that have sparse historical data.

At operation 240, the multi-channel bid generation system 100 present visualizations to an advertiser in order to illustrate potential bidding strategies to the advertiser, and/or to show how changes in advertising budgets may affect predicted revenue to be gained. In various embodiments, operation 240 may be performed by the visualization module 180. In some embodiments, the visualization module 180 may present visualizations of relationships between predicted revenue and advertising budget amounts. In various embodiments, the visualization module 180 may present, to an advertiser, visual indications of how a bidding strategy may be distributed across multiple channels. In various embodiments, these distributions may comprise distributions of multi-channel revenue. In various embodiments, these distributions may comprise distributions of multi-channel cost, such as illustrating the amounts of bids which are recommended as part of a bidding strategy.

Next, at operation 250, the multi-channel bid generation system 100 may facilitate execution of the bids. In various embodiments, operation 250 may be performed by the bid generation module 170. In various embodiments, as part of operation 250, the bid generation module 170 may implement, monitor, and/or adjust the advertiser's marketing strategy or spending decisions in the context of the changing marketing options available. In various embodiments, the bid generation module 170 may take into account changing objectives, budgets and requirements of the organization, such as by re-optimizing using the model. In various embodiments, the multi-channel bid generation system 100 may be configured to take various events, based on recent events of a advertisee 110 suggesting that the advertisee has a higher propensity to convert. For example, if the advertisee is determined to be likely to convert, the bid generation module 170 may generate bids to show more advertisements at specific sites, display exchanges and/or display network, to pay for additional listings on search engines, or to change the maximum willingness to pay for keywords that the user is deemed likely to click on. After operation 250, the process may then end.

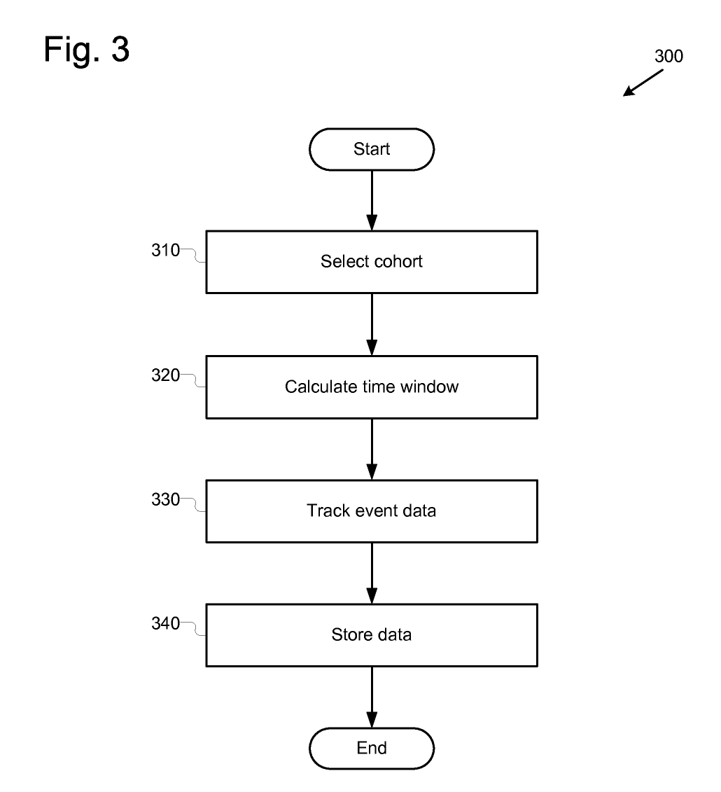

FIG. 3 illustrates an example process 300 for the multi-channel bid generation system 100 to track an implicit revenue event history, from which it may generate a bidding strategy. In various embodiments, the operations illustrated in process 300 may be combined, split into multiple separate operations, or omitted entirely. In various embodiments, process 300 may be performed as an implementation of operation 210 of process 200. The process may begin at operation 310, where, in some embodiments, the multi-channel bid generation system 100 may facilitate the selection of a suitable cohort of advertisees from which to obtain data. At operation 320, the multi-channel bid generation system 100 may facilitate calculation of a time window in which data will be collected for the selected cohort. For example, the multi-channel bid generation system 100 may select a cohort of all advertisees seen by the multi-channel bid generation system 100 for the first time during a pre-defined time window, and the time window may be calculated to match the selection of the cohort. In various embodiments, the cohort may be selected by a user, such as by selecting from options presented to the user by the multi-channel bid generation system 100. In other embodiments, the multi-channel bid generation system 100 may itself select a suitable cohort. The cohort may be defined, in various embodiments, according to various personal or other data, such as, for example, by demographics, geographic location, income, interest, and/or interactions with the system 100. In various embodiments, the time window may be calculated by the multi-channel bid generation system 100 itself or may be input by a user, such as on an interface provided by the multi-channel bid generation system 100. In some embodiments, the multi-channel bid generation system 100 may calculate the fraction of advertisees whose event details are captured within a number of days since a first event.

At operation 330, the multi-channel bid generation system 100 may track event data. In various embodiments, the event data represents implicit revenue intent expressed by the advertiser. In various embodiments, event data may track impressions, clicks, and/or conversions on multiple channels such as search advertising, display advertising and social media. In various embodiments, these interactions may be tracked through views on one or more of: web pages, emails, and/or social applications. In one embodiment, the data may also comprise total counts for different event types. At operation 340, the data collected is stored, such as in the event history storage 115.

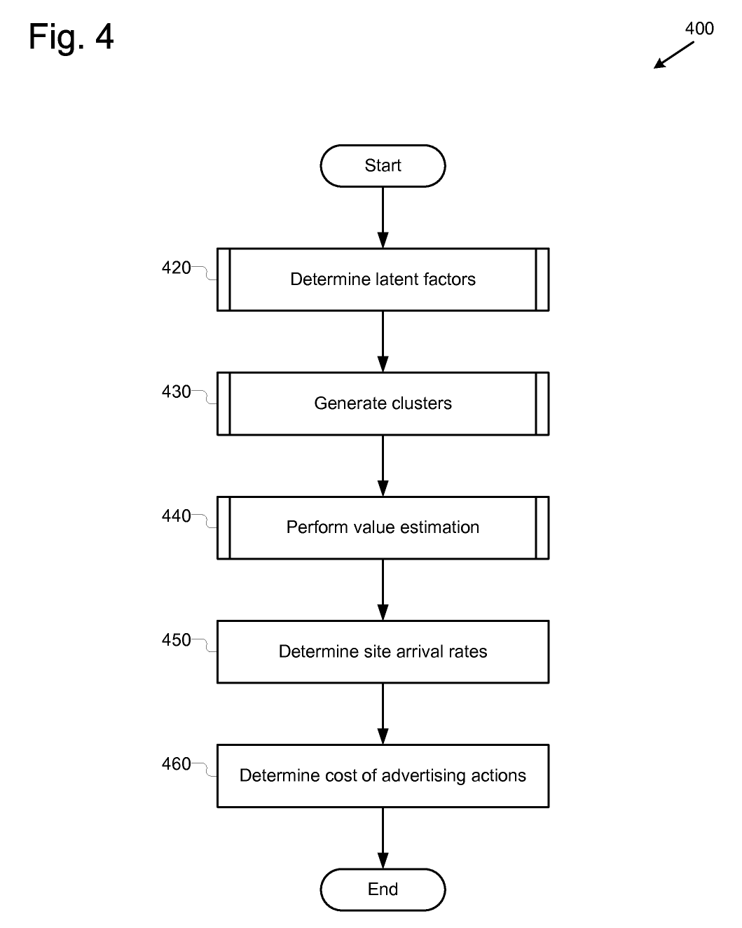

FIG. 4 illustrates an example process 400 for the multi-channel bid generation system 100 to generate a multi-channel advertising model which the system 100 may use to generate a bidding strategy. In various embodiments, the operations illustrated in process 400 may be combined, split into multiple separate operations, or omitted entirely. In various embodiments, process 400 may be performed as an implementation of operation 220 of process 200. The process may begin at operation 420, where the multi-channel bid generation system 100 may determine one or more latent factors for use in generating the model. In various embodiments, operation 420 may be performed by the latent factor determination module 120. Embodiments of various operations performed as part of operation 410 are described below.

At operation 430, the multi-channel bid generation system 100 may generate clusters, such as clusters of advertisees and/or event metadata, for use in use in generating the model. In various embodiments, operation 430 may be performed by the clustering module 130. Embodiments of various operations performed as part of operation 430 are described below. At operation 440, the multi-channel bid generation system 100 may perform value estimation for advertisees. For example, through operation 440, the multi-channel bid generation system 100 may estimate the probabilities for an advertisee to convert to a revenue metric of interest to the advertiser given a set of events and event timestamps that occur for the advertisee. In various embodiments, the system 100 may predict revenue generated by the advertisee from the estimated probability. In various embodiments, operation 440 may be performed by the value estimation module 140. Embodiments of various operations performed as part of operation 440 are described below.

At block 450, the multi-channel bid generation system 100 may determine site arrival rates for various advertisees. In various embodiments, operation 450 may be performed by the arrival prediction module 150. At block 460, the multi-channel bid generation system 100 may estimate relationships between bids and costs incurred from these bids. In various embodiments, operation 460 may be performed by the bid/cost relationship estimation module 160, such as by using historical spend and bid data stored on historical spend and bid data storage 165 to perform the estimation. In various embodiments, methods to estimate this relationship include techniques such as linear regression, log-linear regression, non-linear regression, and time series models.

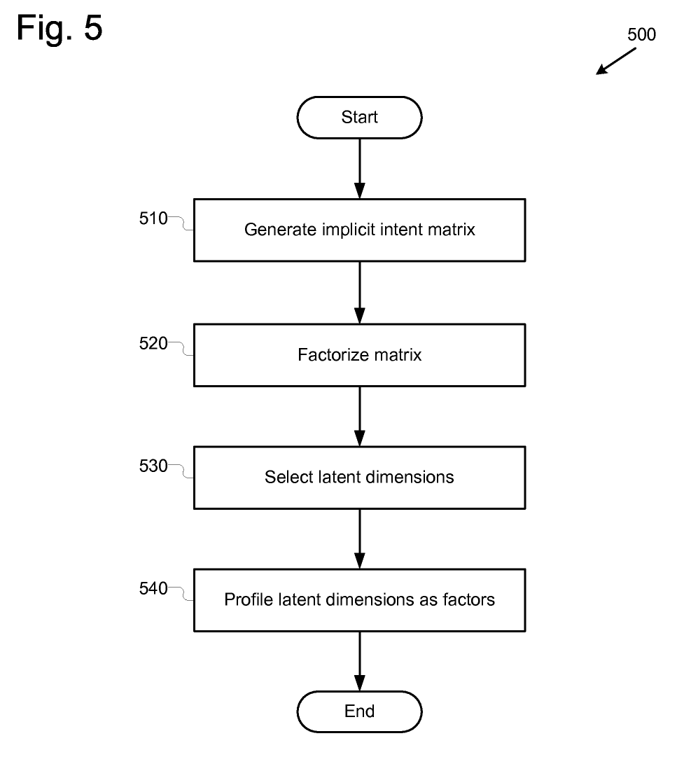

FIG. 5 illustrates an example process 500 for the latent factor determination module 120 to determine latent factors for the a multi-channel advertising model. In various embodiments, the operations illustrated in process 500 may be combined, split into multiple separate operations, or omitted entirely. In various embodiments, process 500 may be performed as an implementation of operation 420 of process 400. The process may begin at operation 510, where the latent factor determination module 120 generates an implicit intent matrix containing metadata information from the event data stored on the event history storage. In various embodiments, the implicit intent matrix may capture the implicit revenue intent expressed by the advertiser for the respective metadata. The metadata may comprise, in various embodiments, indications of one or more of keywords, web sites, advertisements, and/or images that that an advertisee interacted with along with measures of numbers of events. In various embodiments, based on the event counts, the multi-channel bid generation system 100 take a time-weighted, convex combination of events observed for each advertisee and come up with implicit revenue intent value. In various embodiments, the implicit intent matrix comprises a sparse matrix.

At operation 520, once the implicit intent matrix is generated, the latent factor determination module 120 may factorize the matrix, as will be recognized by one of ordinary skill in the art. In various embodiments this factorization may produce a scaled and rotated approximation to the original matrix. In various embodiments, the latent factor determination module may estimate the approximate matrix by solving an optimization problem with regularization parameters. The optimization function objective may, in some embodiments, be the difference between the observed implicit intent for the advertisee and a mixed effect model estimate for each advertisee-metadata combination. In various embodiments, a regularization parameter proportional to the value of parameters in the mixed effect model may be added to the optimization function to prevent over-fitting.

At operation 530, the latent factor determination module 120 may select latent dimensions based on the matrix decomposition. In one embodiment, the latent factor determination module 120 may select latent dimensions by selecting the first n dimensions that correspond to the highest n eigenvalues of the matrix. In various embodiments, these n eigenvalues may account for most of the observed variability in the data. Then, at operation 540, the latent factor determination module 120 may create profiles for the n selected dimensions. In one embodiment, the latent factor determination module 120 may create these profiles by evaluating loadings of the metadata dimensions on the reduced set of n selected dimensions. The module 120 may then use information like website type, keyword groupings, domain of social apps etc. to profile the selected dimensions. The process may then end.

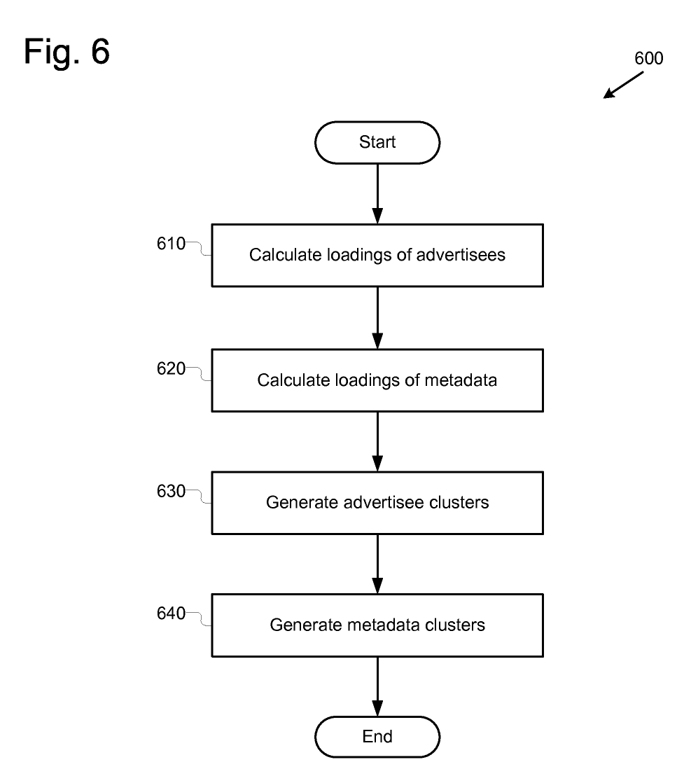

FIG. 6 illustrates an example process 600 for the clustering module 130 to generate clustering of advertisees and metadata for use in the multi-channel advertising model. In various embodiments, the operations illustrated in process 600 may be combined, split into multiple separate operations, or omitted entirely. In various embodiments, process 600 may be performed as an implementation of operation 430 of process 400.

The process may begin at operation 610, where the clustering module 130 may calculate loadings and/or weights of the advertisee on the latent dimensions determined during the process of FIG. 5. At operation 620, the clustering module 130 may calculate the loadings of the metadata on these same latent dimensions. During the next two operations, for each of the calculated loading sets, the clustering module 130 may use standard clustering processes, such as k-means, hierarchical processes, and/or probabilistic processes, to generate clusters. For example, at operation 630, the clustering module may generate advertisee clusters. In one embodiment, these clusters may represent segmentation of users. At operation 640, the clustering module may generate clusters from meta data, such as clusters of web sites or advertisers. In various embodiments, the degree to which the clustering module is successful in generating metadata clusters may depend on the level of aggregation in the metadata space. The process may then end.

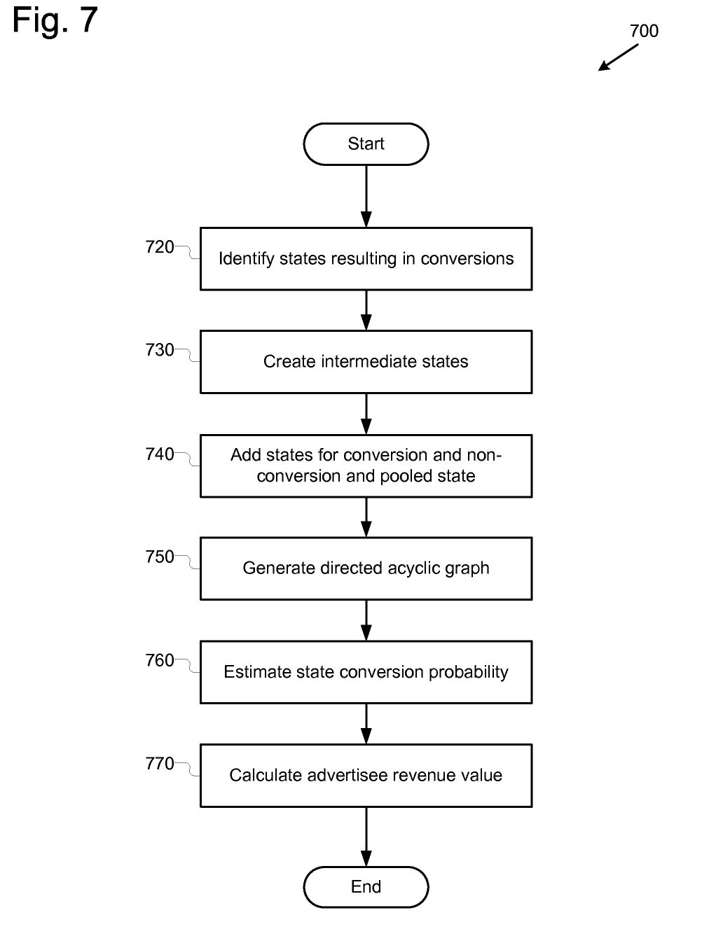

FIG. 7 illustrates a first example process 700 for the value estimation module 140 to perform value estimation for use in the multi-channel advertising model. In various embodiments, process 700 may be performed to estimate the probability of conversion for an advertisee, given a set of events and event timestamps that occur for the advertisee. In various embodiments, the operations illustrated in process 700 may be combined, split into multiple separate operations, or omitted entirely. In various embodiments, process 700 may be performed as an implementation of operation 440 of process 400.

In various embodiments of the illustrated process 700, the process may be performed to find the value of a particular event, at a given point in time, by taking into account a set and sequence of prior events that the advertisee has undergone before the particular event. Various embodiments of process 700 may be performed without reference to temporal or time-based data. In these embodiments, the value estimation module 140 may calculate a probability that an advertisee will convert to a first revenue event in a sales funnel. Given this information, the value estimation module 140 may find an overall value of the advertisee based on the calculated probabilities.

In various embodiments, process 700 may generate a network flow model whose parameters will be estimated recursively by a dynamic programming, or backward induction, approach. States in the network flow model may, in various embodiments, represent sets of events that have occurred between a first event and an occurrence of a conversion event under consideration. In various embodiments, events include, by way of example and not limitation, search engine marketing clicks; page views, such as from organic search clicks; display clicks; display impressions; social media impression; social media clicks; mobile ad impressions; and/or mobile ad clicks.

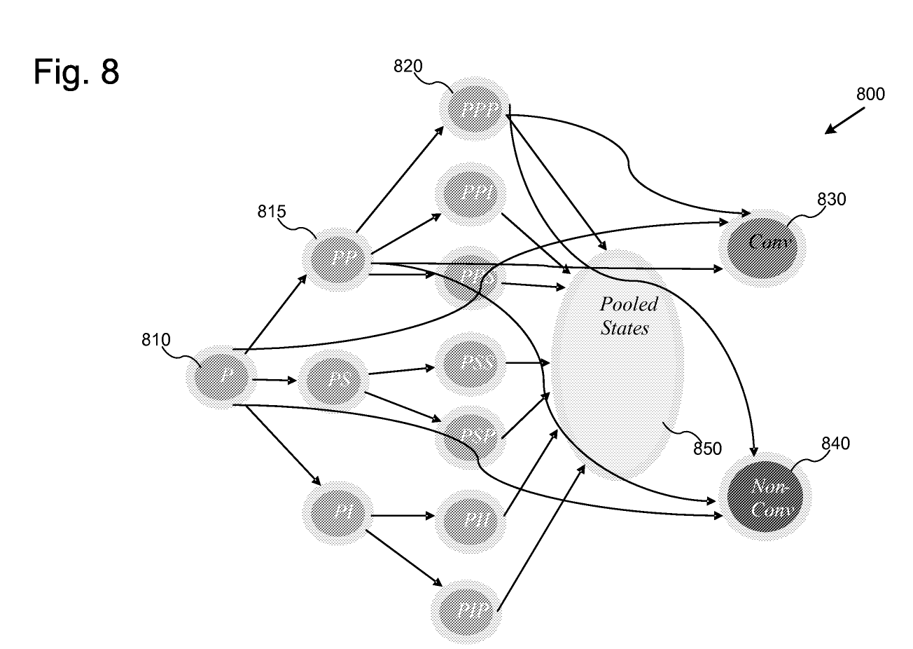

FIG. 8 illustrates an example embodiment of a network flow model, such as may be created by process 700. In the example of FIG. 8, each state represents a series of events that have occurred between the first event an a current time; in FIG. 8, “P” represents a click tracked through search engine optimization (“SEO”), “S” corresponds to a click tracked through search engine marketing (“SEM”), and “I” represents a banner ad impression. Thus, node 810 represents a state after a search-engine-optimized click, and node 820 represents a state reached after the SEO click of node 810 followed by two further SEO clicks. Additionally, in various embodiments, the network flow model may contain nodes explicitly representing conversion states (node 830), non-conversion states (node 840), as well as a “pooled states” state (node 850). In various embodiments, the non-conversion states may correspond to a set of states that did not result in a single conversion. In various embodiments, the pooled states may include a set of event sequence states that are grouped together to reduce conversion rate variance and deal with data sparsity effects.

Process 700 may begin at operation 720, where the value estimation module 140 may identify those states (e.g. sets of events) which result in a conversion. For example, at operation 720, the value estimation module 140 may identify the state repressed by node 820 as a state that may lead to conversion. At operation 730, the value estimation module 140 may create intermediate states representing event sequences between the first event and converting states. An example of an intermediate state is illustrated in FIG. 8 by node 815. At operation 740, the value estimation module 140 may add states for conversion, non-conversion, as well as a pooled state.

At operation 750 the value estimation module 140 may generate a directed acyclic graph with nodes representing the previously-created first, conversion, non-conversion, pooled, and intermediate states. Next, at operation 760, the value estimation module 140 may estimate a state conversion probability for each state. In various embodiments, the value estimation module 140 may use dynamic programming, such as backward induction, to perform the estimation. Then, at operation 770, the value estimation module 140 may calculate a revenue value for the advertisee at each state. In various embodiments, the value estimation module 140 may calculate the advertisee value as a function of the state the advertisee is at and the previously-calculated conversion probability.

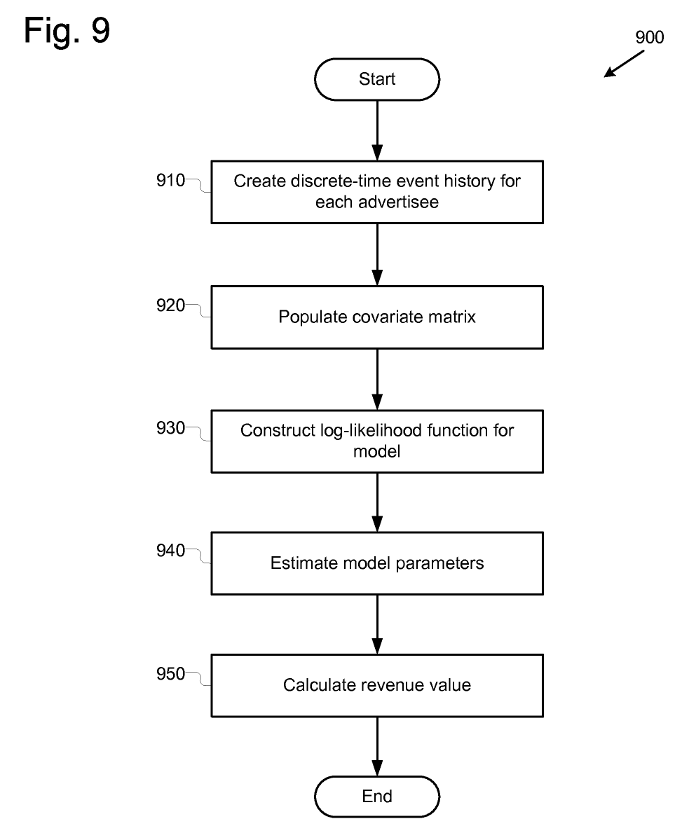

FIG. 9 illustrates a second example process 900 for the value estimation module 140 to perform value estimation for use in the multi-channel advertising model. In various embodiments, process 900 may be performed to estimate the value of an advertisee probability of conversion for an advertisee, given a set of events and event timestamps that occur for the advertisee. In various embodiments, the operations illustrated in process 900 may be combined, split into multiple separate operations, or omitted entirely. In various embodiments, process 900 may be performed as an implementation of operation 440 of process 400.

In various embodiments of the illustrated process 900, the value estimation module 140 may estimate the value of an advertisee based on the sequence of events that occur for the advertisee along with time stamps for the sequence of events. In contrast to the process of FIG. 7, various embodiments of process 900 may be performed with reference to these timestamps. In these embodiments, the value estimation module 140 may seek to fit a discrete time hazard model to estimate the conversion probability of an advertisee at a given point in time. In various embodiments, covariates to the model include, but are not limited to, web sites, web site categories, search keyword categories, social media interests, language, ad size, ad type (e.g. flash, html), geo-location, time since first event, first event type, time since last event, and others.

In various embodiments, the model generated through operation of process 900 may capture a baseline hazard function based on certain covariates. In other embodiments, the model generated through operation of process 900 may incorporate shifts to the baseline hazard function which are conditional on other covariates. The process 900 may result in a model where a conditional probability of conversion is re-parameterized as a logistic function of the covariates and the associated time periods that events for the covariates occurred in. In some embodiments, the model may be conditional on the advertisee not having converted in any time periods prior to one for which the conversion probability is estimated.

The process may begin at operation 910, where the value estimation module 140 may create a discrete-time event history for each advertisee. In various embodiments of operation 910, the value estimation module 140 may capture a time effect in the model by using a sequence of dummy variables that index for discrete time intervals and which contain event counts.

Next, at operation 920, the value estimation module 140 may populate a matrix for the covariates. In various embodiments, the occurrence of an event of interest, such as a conversion may also be recorded as a dummy variable with value 1 in the time period in which the conversion occurs. In various embodiments, the dummy variable may have a value of 0 in all other time periods for the given advertisee. In some embodiments, the value estimation module 140 may also populate the covariate matrix with values for cookie drop-out and/or tracking code deletion for channels which do not use cookies for tracking In various embodiments, these drop-outs or deletions may be captured through a value between 0 and 1 for each advertisee. This capture may indicate that the value estimation module 140 believes censoring has occurred for the advertisee.

At operation 930, the value estimation module 140 may construct a log-likelihood function of the discrete time hazard function in terms of the covariates. In various embodiments, this may include the dummy variables and the hazard probability parameters. At operation 940, the value estimation module 140 may estimate the parameters of the model using a modified, logistic regression approach. In some embodiments, this approach is used in lieu of a direct, maximum likelihood estimation technique. From these model parameters, at operation 950, the value estimation module 140 may then calculate a revenue value for the advertisee. The process may then end.

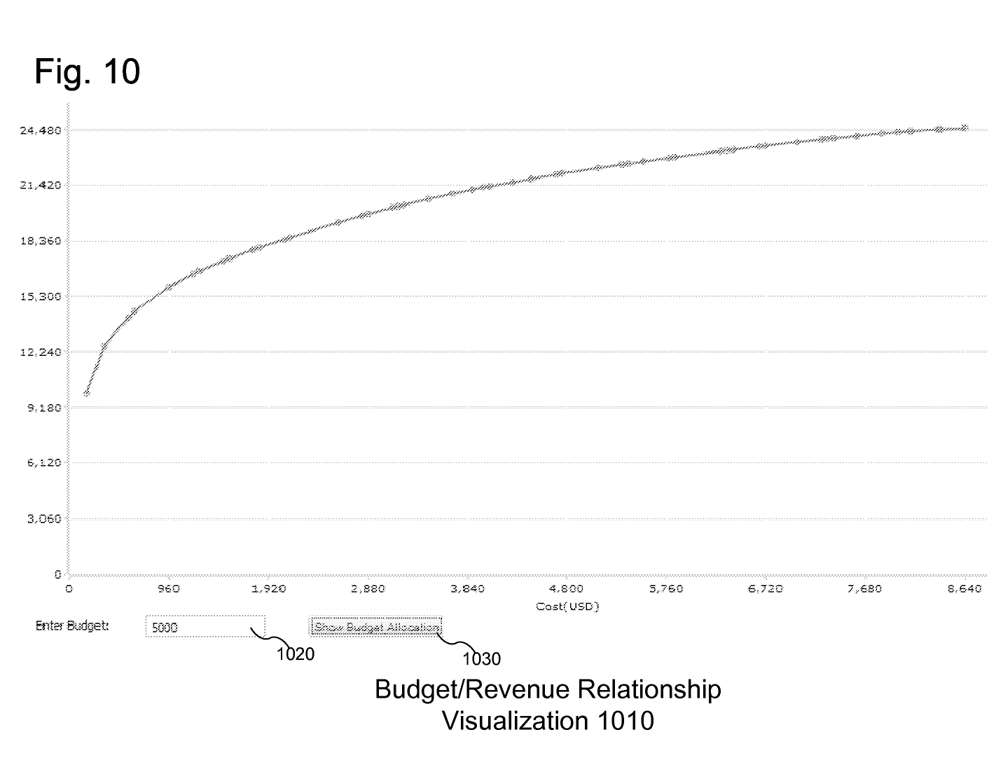

FIG. 10 illustrates an example visualization of predicted revenue based on various budget amounts. In various embodiments, the visualization example illustrated in FIG. 10 may be generated by the visualization module 180 of the multi-channel bid generation system 100. In various embodiments, the visualization module 180 may generate a budget/revenue relationship visualization 1010, such as the example illustrated in FIG. 10. This budget/revenue relationship visualization 1010 may show an advertiser what revenue is predicted for the advertiser based on various advertising budget amounts. Thus, in the example illustrated, predicted revenue increases as advertising budgets increase. However, the relationship may not be linear, as illustrated, for example, in FIG. 10. In various embodiments, the relationship between predicted revenues and advertising budgets may be generated based, at least in part, on information received from the value estimation module 140.

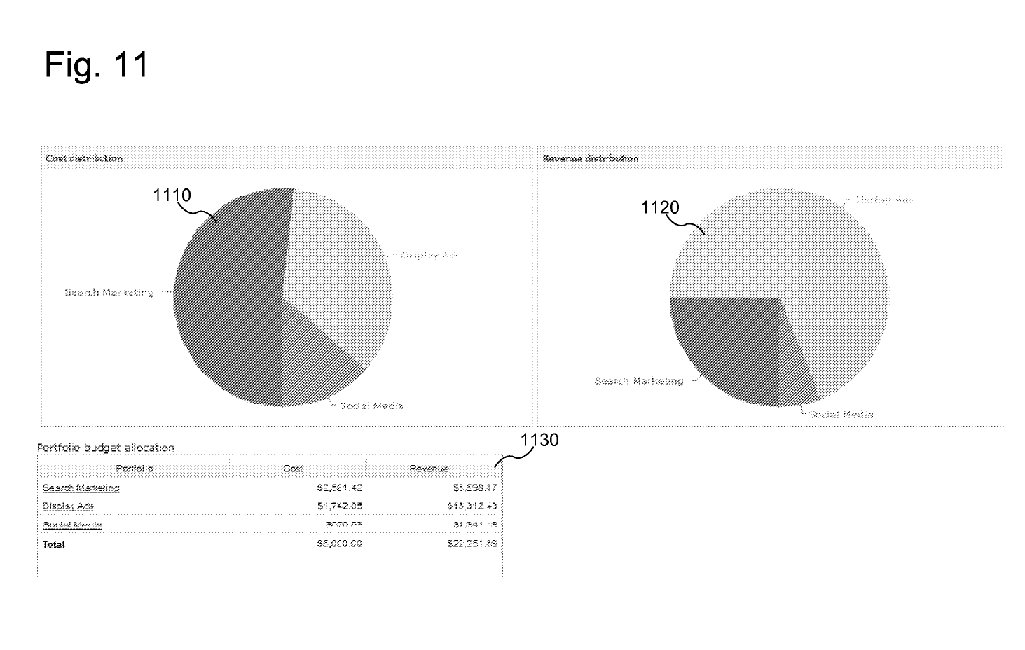

In various embodiments, the visualization module 180 may allow an advertiser to enter a budget amount, such as at entry point 1020 of FIG. 10, and to activate an element to show one or more budget allocations, such as at element 1030 of FIG. 10. FIG. 11 illustrates example visualizations of suggested budget allocations which may, in various embodiments, be generated in response to such an activation. In the examples of FIG. 11, the visualizations are made with respect to a proposed budget amount of $5000. In various embodiments, the budget allocation visualizations may be generated based, at least in part, on information received from the value estimation module 140 and/or the bid generation module 170.

In various embodiments, visualizations of budget allocations may include a visualization of a cost distribution. In the visualization, the visualization module 180 generates a cost distribution visualization 1110. This visualization shows how the $5000 advertising budget may be divided up amongst various channels, such as search marketing, display ads, and social media. In various embodiments, visualizations of budget allocation may include a visualization of revenue distribution, such as revenue distribution visualization 1120. This visualization shows how a predicted revenue of $22,251,69 (which can be seen as corresponding to a $5000 budget allocation in the visualization of FIG. 10), is predicted to be generated from various channels. For example, in visualization 1120, the revenue may come from various channels, such as search marketing, display ads, and social media.

In some embodiments, cost and revenue information may also be visualized in a quantitative form, such as in the portfolio budget allocation 1130. This shows the same information shown in the visualizations 1110 and 1120, but attaches specific quantities to the channels. In various embodiments, the visualizations provided by the visualization module 180 may ad an advertiser in selecting a bidding strategy. In one example, using these visualizations allows an advertiser to more easily understand the relationship between cost spent on various channels and revenue predicted to arrive from those channels. Hence, an advertiser seeing the visualizations of FIG. 11 may realize that display ads are actually producing more revenue relative to their cost than search marketing. This may provide insights that are not produced in other systems, such as those described earlier that tend to over-accentuate the results of intent-based channels over channels that provide awareness, interest, and/or desire. In various embodiments, the visualization examples, and other visualizations provided by the visualization module 180 may be presented to an advertiser as a web page on a web browser. In other embodiments, the visualizations may be presented through a dedicated software application.

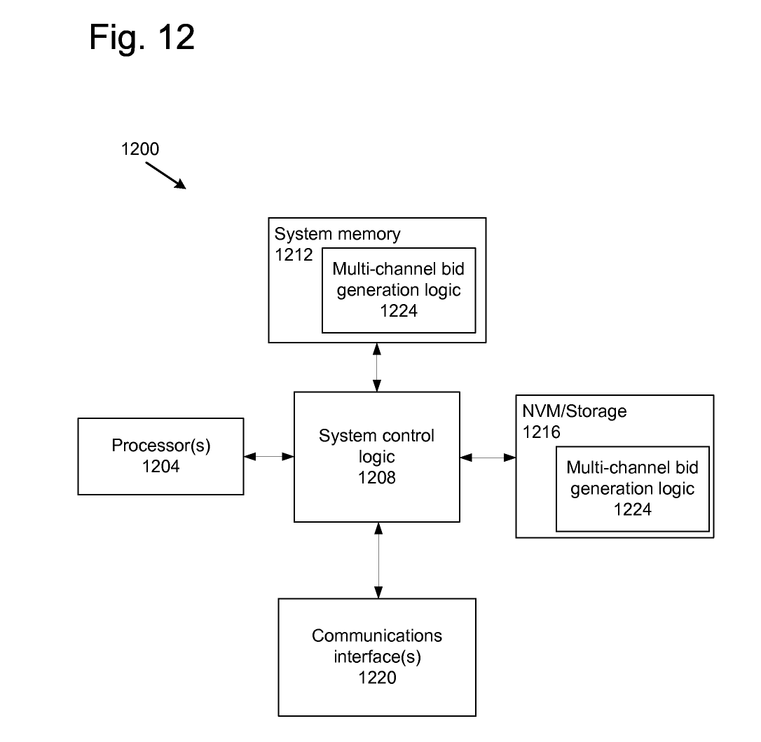

The techniques and apparatuses described herein may be implemented into a system using suitable hardware and/or software to configure as desired. FIG. 12 illustrates, for one embodiment, an example system 1200 comprising one or more processor(s) 1204, system control logic 1208 coupled to at least one of the processor(s) 1204, system memory 1212 coupled to system control logic 1208, non-volatile memory (NVM)/storage 1216 coupled to system control logic 1208, and one or more communications interface(s) 1220 coupled to system control logic 1208.

System control logic 1208 for one embodiment may include any suitable interface controllers to provide for any suitable interface to at least one of the processor(s) 1204 and/or to any suitable device or component in communication with system control logic 1208.

System control logic 1208 for one embodiment may include one or more memory controller(s) to provide an interface to system memory 1212. System memory 1212 may be used to load and store data and/or instructions, for example, for system 1200. System memory 1212 for one embodiment may include any suitable volatile memory, such as suitable dynamic random access memory (DRAM), for example.

System control logic 1208 for one embodiment may include one or more input/output (I/O) controller(s) to provide an interface to NVM/storage 1216 and communications interface(s) 1220.

NVM/storage 1216 may be used to store data and/or instructions, for example. NVM/storage 1216 may include any suitable non-volatile memory or non-transitory computer-readable media, such as flash memory, for example, and/or may include any suitable non-volatile storage device(s), such as one or more hard disk drive(s) (HDD(s)), one or more solid-state drive(s), one or more compact disc (CD) drive(s), and/or one or more digital versatile disc (DVD) drive(s) for example.

The NVM/storage 1216 may include a storage resource physically part of a device on which the system 1200 is installed or it may be accessible by, but not necessarily a part of, the device. For example, the NVM/storage 1216 may be accessed over a network via the communications interface(s) 1220.

System memory 1212 and NVM/storage 1216 may include, in particular, temporal and persistent copies of logic 1224. Logic 1224 may be configured to enable system 1200, in response to operation of the logic, to practice some or all aspects of the multi-channel bid generation techniques described earlier. In various embodiments, logic 1224 may be implemented via programming instructions of any one of a number of programming languages, including but not limited to C, C++, C#, HTML, XML, and so forth.

Communications interface(s) 1220 may provide an interface for system 1200 to communicate over one or more network(s) and/or with any other suitable device. Communications interface(s) 1220 may include any suitable hardware and/or firmware. Communications interface(s) 1220 for one embodiment may include, for example, a network adapter, a wireless network adapter, a telephone modem, and/or a wireless modem. For wireless communications, communications interface(s) 1220 for one embodiment may use one or more antenna(s).

For one embodiment, at least one of the processor(s) 1204 may be packaged together with logic for one or more controller(s) of system control logic 1208. For one embodiment, at least one of the processor(s) 1204 may be packaged together with logic for one or more controllers of system control logic 1208 to form a System in Package (SiP). For one embodiment, at least one of the processor(s) 1204 may be integrated on the same die with logic for one or more controller(s) of system control logic 1208. For one embodiment, at least one of the processor(s) 1204 may be integrated on the same die with logic for one or more controller(s) of system control logic 808 to form a System on Chip (SoC).

In various embodiments, system 1200 may have more or fewer components, and/or different architectures.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the disclosure. Those with skill in the art will readily appreciate that embodiments of the disclosure may be implemented in a very wide variety of ways. This disclosure is intended to cover any adaptations or variations of the embodiments discussed herein. Therefore, it is manifestly intended that embodiments of the disclosure be limited only by the claims and the equivalents thereof.

What is claimed is:

1. A computer-implemented method for bid generation for a multi-channel advertising environment, the method comprising:
tracking, by a computing device, an event history for an individual advertisee across a plurality of advertising channels the event history including one or more non-conversion advertising events;
evaluating, by the computing device, the event history, including the one or more non-conversion advertising events, to determine a value of performing one or more potential advertising events for the individual advertisee; and
generating one or more bids for the one or more potential advertising events in one or more of the plurality of channels, based on the results of said evaluating, or providing the results of said evaluating for said generating.

2. The method of claim 1, wherein collecting an event history for an individual advertisee across a plurality of advertising channels comprises using web browser cookies to track the individual advertisee.

3. The method of claim 1, wherein collecting an event history for an individual advertisee across a plurality of advertising channels comprises using tracking codes to track the individual advertisee.

4. The method of claim 1, wherein evaluating the event history comprises generating, by the computing device, a multi-channel advertising model based at least in part on the event history.

5. The method of claim 4, wherein generating one or more bids comprises optimizing, by the computing device, an objective function based at least in part on the generated model.

6. The method of claim 5, further comprising executing the bidding strategy by performing one or more bids for advertising events as directed by the bidding strategy.

7. The method of claim 5, wherein optimizing the objective function comprises optimizing the objective function subject to one or more constraints.

8. The method of claim 4, wherein generating the multi-channel advertising model comprises:
determining, by the computing device, one or more latent factors based on the event history;
generating, by the computing device, clusters of advertising entities and event metadata; and
performing, by the computing device, value estimation for advertisees.

9. The method of claim 8, wherein generating the multi-channel advertising model further comprises:
determining, by the computing device, arrival rates of advertisees at one or more web sites for which the multi-channel advertising model is developed; and
determining, by the computing device, costs of advertising events.

10. The method of claim 8, wherein determining one or more latent factors comprises:
generating, by the computing device, an implicit revenue intent matrix;
factorizing, by the computing device, the implicit revenue intent matrix;
selecting, by the computing device, one or more latent dimensions in the implicit revenue intent matrix; and
profiling, by the computing device, latent dimensions as latent factors.

11. The method of claim 8, wherein generating clusters of advertising entities comprises:
calculating, by the computing device, loadings of advertisees; and
generating, by the computing device, advertisee clusters.

12. The method of claim 11, wherein generating clusters of advertising entities further comprises:
calculating, by the computing device, loadings of metadata; and
generating, by the computing device, metadata clusters.

13. The method of claim 8, wherein performing the value estimation for advertisees comprises performing, by the computing device, a value estimation based on a sequence of events undergone by an individual advertisee.

14. The method of claim 13, wherein performing a value estimation based on a sequence of events comprises computing, by the computing device, a probability that the individual advertisee will convert to a revenue event for the advertiser based on the sequence of events.

15. The method of claim 14, wherein computing a probability that the individual advertisee will convert to a revenue event for the advertiser based on the sequence of events comprises:
creating, by the computing device, a model with states representing sequences of events;
estimating, by the computing device, conversion probabilities for states; and
estimating, by the computing device, value for an advertisee as a function of a state the advertisee is at and the conversion probability for the state.

16. The method of claim 15, wherein creating the model comprises:
identifying, by the computing device, states which result in conversions;
creating, by the computing device, intermediate states;
adding, by the computing device, model states for conversion and non-conversion events;
adding, by the computing device, a pooled state; and
creating, by the computing device, a directed acyclic graph on the created states.

17. The method of claim 13, wherein performing a valuation based on a sequence of events comprises performing, by the computing device, the valuation based on a time-stamped sequence of events.

18. The method of claim 17, wherein performing the valuation based on a time-stamped sequence of events comprises fitting, by the computing device, a discrete-time hazard model to estimate a conversion probability for the individual advertisee at a given point in time.

19. The method of claim 18, wherein fitting the discrete-time hazard model comprises:
creating, by the computing device, a discrete-time event history for the individual advertisee;
populating, by the computing device, a covariate matrix for time-related variables, conversion occurrence, and censoring;
generating, by the computing device, a log-likelihood function for the discrete-time hazard model; and
estimating, by the computing device, model parameters for the model.

20. The method of claim 1, further comprising generating, by the computing device, one or more visualizations describing the one or more bids to an advertiser.

21. The method of claim 20, wherein generating one or more visualizations comprises generating a cost distribution visualization describing, for the one or more bids, how costs will be distributed across the plurality of channels.

22. The method of claim 20, wherein generating one or more visualizations comprises generating a cost distribution visualization describing, for the one or more bids, how revenue is predicted to be generated across the plurality of channels.

23. A system for generating bids for multi-channel environment, the system comprising:
one or more computer processors;
an event history storage coupled to the one or more computer processors, the event history storage configured to store a history of events for one or more advertisees, including one or more advertising events which are not based on advertisee intent;
one or more multi-channel advertising modeling modules coupled to the event history storage and configured to control the one or more processors, in response to operation by the one or more processors, to generate a multi-channel advertising model based at least in part on the stored event history; and
a bid generation module, coupled to the one or more multi-channel advertising modeling modules and configured to control the one or more processors, in response to operation by the one or more processors, to generate a bidding strategy directing bids for advertising events based at least in part on the multi-channel advertising model.

24. The system of claim 23, wherein the event history storage is further configured to track event history information based on web browser cookies or tracking codes.

25. The system of claim 23, wherein the one or more multi-channel advertising modeling modules comprises a latent factor modeling module configured to control the one or more processors, in response to operation by the one or more processors, to determine one or more latent factors based on the stored event history.

26. The system of claim 23, wherein the one or more multi-channel advertising modeling modules comprises a clustering module configured to control the one or more processors, in response to operation by the one or more processors, to cluster advertising entities and event metadata.

27. The system of claim 23, wherein the one or more multi-channel advertising modeling modules comprises a value estimation module configured to control the one or more processors, in response to operation by the one or more processors, to perform value estimation for advertisees.

28. The system of claim 23, further comprising an arrival prediction module configured to control the one or more processors, in response to operation by the one or more processors, to predict arrival rates of advertisees at one or more web sites for which the multi-channel advertising model is developed.

29. The system of claim 23, further comprising a bid/cost relationship estimation module configured to control the one or more processors, in response to operation by the one or more processors, to estimate costs of bidding for advertising events.

30. The system of claim 23, further comprising a visualization module configured to control the one or more processors, in response to operation by the one or more processors, to generate one or more visualizations describing distributions of costs and/or revenues for the bidding strategy across the multi-channel environment.

31. An article of manufacture, comprising:
a tangible computer-readable storage medium; and
a plurality of computer-executable instructions stored on the tangible computer-readable storage medium, wherein the computer-executable instructions, in response to execution by an apparatus, cause the apparatus to perform operations for generating a bidding strategy for directing bidding for advertising events, the operations including:
collecting an event history for an advertisee across a plurality of advertising channels including one or more non-conversion advertising events;
generating a multi-channel advertising model based at least in part on the event history;
optimizing an objective function based at least in part on the generated model to determine a bidding strategy including one or more bids for advertising events in the plurality of advertising channels; and
executing the bidding strategy by performing one or more bids for advertising events as directed by the bidding strategy in the plurality of advertising channels.

32. The article of claim 31, wherein collecting an event history for an individual advertisee across a plurality of advertising channels comprises using web browser cookies or tracking codes to track the individual advertisee.

33. The article of claim 31, wherein generating a multi-channel advertising model comprises:
determining one or more latent factors based on the event history;
generating clusters of advertising entities;
performing value estimation for advertisees;
determining arrival rates of advertisees at one or more web sites for which the multi-channel advertising model is developed; and
determining costs of advertising events.

34. The article of claim 32, wherein determining one or more latent factors comprises:
generating an implicit revenue intent matrix;
factorizing the implicit revenue intent matrix;
selecting one or more latent dimensions in the implicit revenue intent matrix; and
profiling latent dimensions as latent factors.

35. The article of claim 32, wherein generating clusters of advertising entities comprises:
calculating loadings of advertisees;
generating advertisee clusters.
calculating loadings of metadata; and
generating metadata clusters.

36. The article of claim 32, wherein performing the value estimation for advertisees comprises computing a probability that the individual advertisee will convert to a revenue event for the advertiser based on the sequence of events.

37. The article of claim 36, wherein computing a probability that the individual advertisee will convert to a revenue event for the advertiser based on the sequence of events comprises:
creating a model with states representing sequences of events;
estimating conversion probabilities for states; and
estimating value for an advertisee as a function of a state the advertisee is at and the conversion probability.

38. The article of claim 32, wherein performing the value estimation for advertisees comprises performing, by the computing device, the value estimation based on a time-stamped sequence of events.

39. The article of claim 38, wherein performing the value estimation based on a time-stamped sequence of events comprises fitting a discrete-time hazard model to estimate a conversion probability for the individual advertisee at a given point in time by:
creating a discrete-time event history for the individual advertisee;
populating a covariate matrix for time-related variables, conversion occurrence, and censoring;
generating a log-likelihood function for the discrete-time hazard model; and
estimating model parameters for the model.

40. The article of claim 31, wherein the operations further include generating a cost distribution visualization describing, for the bidding strategy, how costs will be distributed across the plurality of advertising channels.

41. The article of claim 31, wherein the operations further include generating a cost distribution visualization describing, for the bidding strategy, how revenue will be generated across the plurality of channels.
